(19) United States
(12) Patent Application Publication
(10) Pub. No.: US 2017/0140461 A1
(43) Pub. Date: May 18, 2017

(54) SYSTEM AND METHOD FOR GENERATING A DYNAMIC CREDIT RISK RATING FOR A DEBT SECURITY

(71) Applicant: Marc Abramowitz, Palo Alto, CA (US)

(72) Inventor: Marc Abramowitz, Palo Alto, CA (US)

(21) Appl. No.: 15/388,447

(22) Filed: Dec. 22, 2016

Related U.S. Application Data
(63) Continuation of application No. 14/198,015, filed on Mar. 5, 2014.

(51) Int. Cl. G06Q 40/02; G06N 3/08

(52) U.S. Cl. CPC G06Q 40/025; G06N 3/08

(57) ABSTRACT

Techniques are provided that receive credit-worthiness, structured and unstructured data from disparate sources including general economic data sources, government data sources, and proprietary data sources. The received data are used by a credit rating model to assign a high-quality credit risk rating for a particular debt security in real time. Techniques are provided for improving accuracy of the rating including machine neural network learning.

### PRIORITY

This application claims priority to U.S. Non-Provisional patent application Ser. No. 14/198,015, filed Mar. 5, 2014, entitled “System and Method for Generating a Dynamic Credit Risk Rating for a Debt Security,” which is currently pending and is hereby incorporated by reference as if submitted in its entirety.

### TECHNICAL FIELD

The present invention relates generally to the field of dynamic credit rating simulation models. More specifically, this invention relates to dynamically computing credit ratings for debt securities in a dynamic credit rating system.

### DESCRIPTION OF THE RELATED ART

Currently, there are a handful of credit rating agencies that are looked to for providing trusted credit ratings of debt securities including but not limited to corporate bonds, government bonds, and the like. Standard & Poor's, Moody's Investor Services, and Fitch Ratings, Inc. are the three most prominent, trusted, and relied upon credit rating agencies in the industry. For example, the credit ratings they produce are used to determine the interest rate a bond issuer is required to pay investors for a particular bond or to determine the funding and capital levels required of the issuer to maintain to cover potential defaults of the bond. These and other credit rating agencies provide credit rating tools and related analytics.

However, despite the seemingly robust credit ratings produced by these large and powerful agencies, the credit rating agencies were found to have played their part in the financial crises of 2007-2008 in part by failing to determine risk correctly.

### SUMMARY OF THE INVENTION

The present invention disclosed herein relates to system and method for generating a dynamic credit risk rating for a debt security. A system and method are provided that receive credit-worthiness, structured and unstructured debt security related data from disparate sources including but not limited to general economic data sources, government data sources, and proprietary data sources. Users can specify particular attributes of the received debt security related data and can specify weights for the attributes. An debt security credit rating algorithm computes a score for each debt security using the weighted attributes for the debt security and then determines a credit rating from the score. Techniques are provided for improving accuracy of the credit rating, for example using neural networks to make adjustments in the attributes or the weights.

### BRIEF DESCRIPTION OF THE DRAWINGS

FIG. 1 is a flow diagram of dynamically generating a bond credit rating, according to an embodiment of the invention;

FIG. 2 is a flow diagram of receiving bond information, according to an embodiment of the invention;

FIG. 3 is a flow diagram of determining or receiving weights for each bond attribute and determining values for each bond attribute, according to an embodiment of the invention;

FIG. 4A-4C is a schematic diagram showing example bond attributes and respective weights, according to an embodiment of the invention;

FIG. 5 is a table of bonds versus specified, quantized corporate bond attributes including bond rating, according to an embodiment of the invention;

FIG. 6 is a flow diagram illustrating the flow of input debt security-related data into a dynamic debt security credit rating component and a dynamic debt security indices component for producing dynamic credit ratings and dynamic debt security credit rating indices, according to an embodiment of the invention;

FIG. 7 is a flow diagram for providing high quality, accurate analytic capabilities for a dynamically generated debt security credit risk rating, according to an embodiment of the invention;

FIG. 8 is a schematic diagram of a system for providing customizable business applications using dynamically generated debt security credit risk ratings, according to an embodiment of the invention;

FIG. 9A-9D are tables of bond portfolios with corresponding bond attributes that are used as input into a dynamic bond rating service and the respective output tables, according to an embodiment of the invention;

FIG. 10 is a schematic diagram showing the percent change in the dynamic credit rating for Bond A, according to an embodiment of the invention; and

FIG. 11 is a block schematic diagram of a system in the exemplary form of a computer system according to an embodiment.

### DETAILED DESCRIPTION OF THE INVENTION

### Generating a Dynamic Credit Risk Rating for a Debt Security

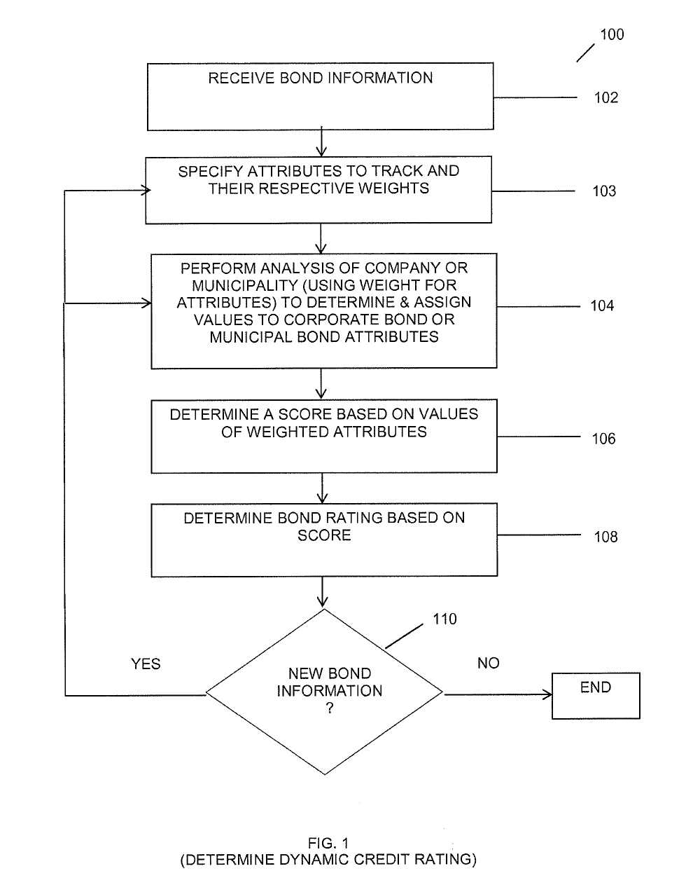

An embodiment of the invention can be understood with reference to FIG. 1, a flow diagram of dynamically generating a bond credit rating 100. At step 102, a debt security credit risk algorithm receives debt security related data, e.g. bondrelated information as illustrated in FIG. 1, from disparate sources both internal to an organization running the algorithm and external such as but not limited to financial and governmental institutions that supply debt security data and related statistics as a service to the financial industry. It should be appreciated that the term, bond, may be used herein for purposes of illustration only and is not meant to be limiting.

At step 103, the algorithm receives information regarding which bond attributes are to be used in the computation of credit risk. For example, price or the cash flows of the organization may be specified as attributes to use in the computation. In an embodiment, a user interface is provided that allows a user to enter the attributes. For example, a user may be provided with a list of attributes that are available in a particular data set within the system running the algorithm. For example, the user may select the cash flows attribute or may decide not to select the cash flows. As well, in an embodiment, the specified attributes can be provided to the algorithm as an input file. For example, the system hosting the algorithm may include an automated process which feeds the list of specified attributed to the algorithm as input.

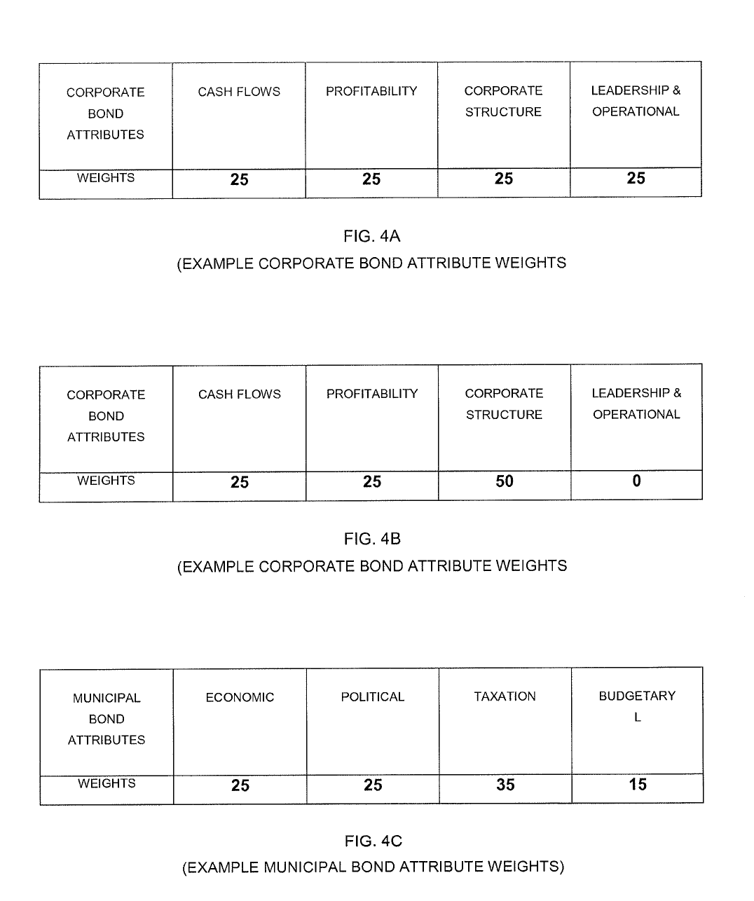

In a similar fashion, the algorithm received weights for each bond attribute. For example, the list of attributes fed to the algorithm may include cash flows and may also include a weight of 25% for the cash flow attribute. The weight specifies the level of important of the weighted attribute. For example, a weight of 25 out of 100 possible means that the attribute given that weight has an importance of 25% compared to the remaining attributes. As another example, cash flows are assigned a weight of 25, a profitability attribute is assigned a weight of 25, and a corporate structure attribute is assigned a weight of 50 (see FIG. 4B.) Thus, in this example, the corporate structure attribute is 100 percent more important than either the cash flows or profitability attributes. Also, in a similar fashion, the weights are user-configurable as are specifying the attributes. That is, a user can enter the amount of weight for each specified attribute or can select from a list of available weight values. In an embodiment, the weights can be provided to the algorithm as an input file, either on a one-off basis or as part of an automated procedure.

It should be appreciated that in an embodiment, the attributes and weights are configurable so that the algorithm captures the factors which the user believes can drive a bond to get upgraded or downgraded, etc.

In an embodiment, one or more of the weights are adjusted by the algorithm. The algorithm incorporates a neural network or other machine learning model that, based on in part but not limited to a comparison of input bond data that includes bond credit ratings with past or predicted bond data that includes bond credit ratings, adjust the weight parameters as necessary to improve the accuracy of the credit rating computation.

In an embodiment, the level of granularity of the ultimately computed credit rating is important, because it is an object of the invention for the credit rating to be sensitive to and to reflect significant changes in the credit risk of the underlying issuer or bond itself. That is, it is important for even slight changes as well as large changes to any of the bond attributes to be detected and reflected in the credit rating. These slight changes as well as large changes are captured in the level of granularity as specified in, but not limited to, the attributes and the respective weights. For example, it is contemplated that a user can enter as many types of attributes as is needed for capturing an important change in the credit rating of the given bond. It further is contemplated that a user can specify the level of accuracy, e.g. to the decimal place, of any particular attribute value.

In an embodiment, the algorithm, can compute a level of change in a particular attribute. For example, the algorithm can compute a one-percent change in the price of the given bond. Further, in an embodiment, threshold values can be input into the algorithm such that the algorithm can determine whether a particular change in value of an attribute has reached or surpassed the threshold. Further, when the threshold is reached or surpassed, the algorithm can perform further operations, such as sending a notification to a user. For example, a user can be notified via email when the price of a particular bond has changed by over a certain percentage.

In a similar fashion, in an embodiment, the algorithm can compute when the credit rating value has changed beyond a specified input threshold value or beyond a tolerance level of change from the previously computed credit rating. As well, the algorithm can alert or otherwise notify a user or another component in the system when such threshold has been passed.

At step 104, the algorithm performs analysis of company or municipality data using in part the attributes weights and generates and assigns values to the corporate bond or municipal bond attributes.

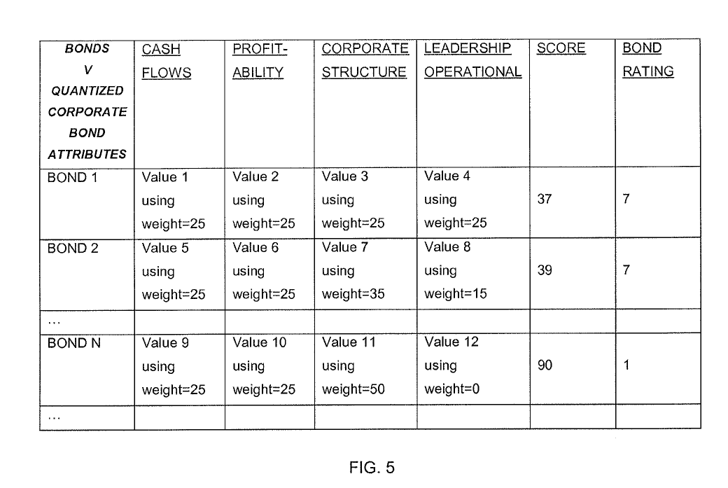

At step 106, the algorithm generates a score based on the values of the weighted attributes. For example, the algorithm can compute that Bond 1 has score 37 and Bond 2 has score 39 (see FIG. 5.)

At step 108, the algorithm generates the bond credit rating based on the computed score. For example, for Bond 1 having score 37, the algorithm determines that the credit rating is 7. Similarly, for Bond 2 having score 39, the algorithm determines that the credit rating is 7. (See FIG. 5.)

At question box 110, the algorithm checks whether there is any new input bond information to process. If not, the algorithm ends. If yes, in an embodiment, control returns to step 103, in which the attributes or the weights can be specified. In another embodiment, the attributes and the weights do not need to be specified again, thus control goes to step 104, at which the analysis is performed.

It should be appreciated that aspects of these steps are user configurable, administratively configurable, or even configurable by design such as by business design. For example, an embodiment can be provided that allows the attributes and weights to be specified for those users whose user profiles permit them to do so, while other users may not have permission to specify the attributes and the weights.

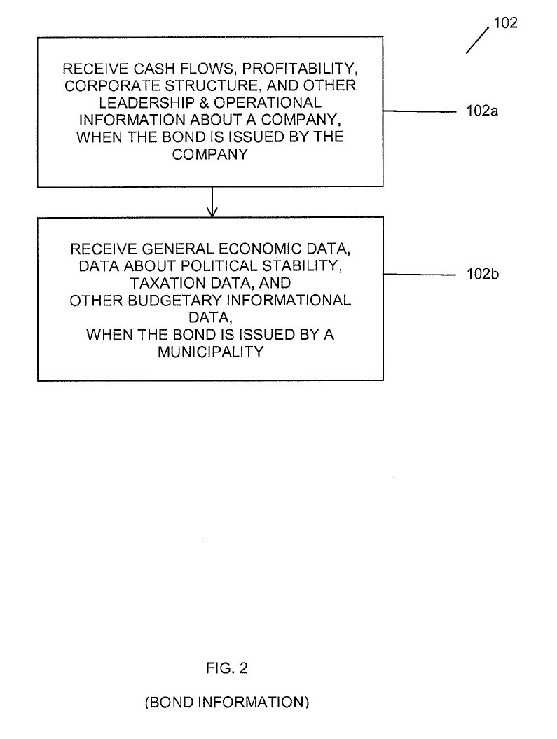

An embodiment can be understood with reference to FIG. 2, a flow diagram of receiving bond information. At step 102a, the algorithm receive cash flows, profitability, corporate structure, and other leadership and operational information about a company, when the bond is issued by the company. Similarly, at step 102b, the algorithm receives general economic data, data about political stability, taxation data, and other budgetary informational data, when the bond is issued by a municipality. It should be appreciated that the particular type of bond information collected and, similarly, the type of attributes defined on top of the collected data, are by way of example only and are not meant to be limiting. For example, an embodiment can collect any other type of data regarding bonds that are considered important to a user in generating a dynamic credit rating. It further should be appreciated that while steps 102a and 102b describe corporate bond data and municipal bond data, respectively, these details are by way of example only and are not meant to be limiting. For example, data regarding Mortgage Backed Securities (MBS) can also be collected.

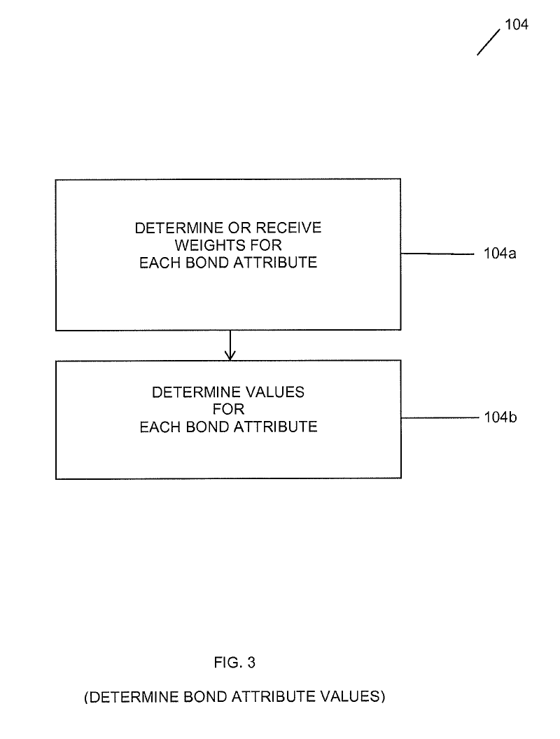

An embodiment can be understood with reference to FIG. 3, a flow diagram of determining or receiving weights for each bond attribute and determining values for each bond attribute. At step 104a, the algorithm determines or receives weights as input for each bond attribute, e.g. as described above. At step 104b, the algorithm determine values for each bond attribute, e.g. as described above.

An embodiment can be understood with reference to FIG. 4, a schematic diagram showing example bond attributes and respective weights. Specifically, FIG. 4A shows example corporate bond attribute weights, FIG. 4B shows another example of corporate bond attribute weights, and FIG. 4C shows example municipal bond attribute weights. It should be appreciated that the details are by way of example only and are not meant to be limiting. For example, an implementation can include ‘bond price’ as an attribute.

An embodiment can be understood with reference to FIG. 5, a table of bonds versus specified, quantized corporate bond attributes including bond rating. In an embodiment, quantized values for corporate bond attributes are generated. In another embodiment, the bond attribute values or weights can be entered. For example, an bond analyst can decide to enter a particular value for an attribute or weight. The weighted attributes are used by the algorithm to generate a score and the score is used to determine a bond rating. In an embodiment, because the level of granularity of the attributes, their values, the weights, their values, and any intermediary values are important, slight changes in bond values can produce slightly different scores. However, a user or the algorithm may determine that certain differences are negligible or otherwise unimportant and should not be counted. Thus, an embodiment provides a mapping of ranges of scores to credit ratings. For example, in FIG. 5, although Bond 1 and Bond 2 have different scores, namely, 37 and 39, respectively, Bond 1 and Bond 2 have the same credit rating, namely, 7. Thus, in this example, both 37 and 39 get mapped to credit rating 7. In an embodiment, the score values, ranges, credit rating values, and mapping of score ranges to credit ratings are configurable.

For example, a user applying the algorithm can configure the above-described variables as part of an input process in running the algorithm and using the algorithm as a tool. As another example, a financial institution can configure any of the above-described variables in accordance with business financial objectives.

### Generating Dynamic Data Sets for Real-Time Bond Rating and Related Analytics

A real-time bond rating system and method deploys dynamic data sets which is responsive to and adjusts related analytics to quantify economic exposure, in a real time fashion to underwriters, etc.

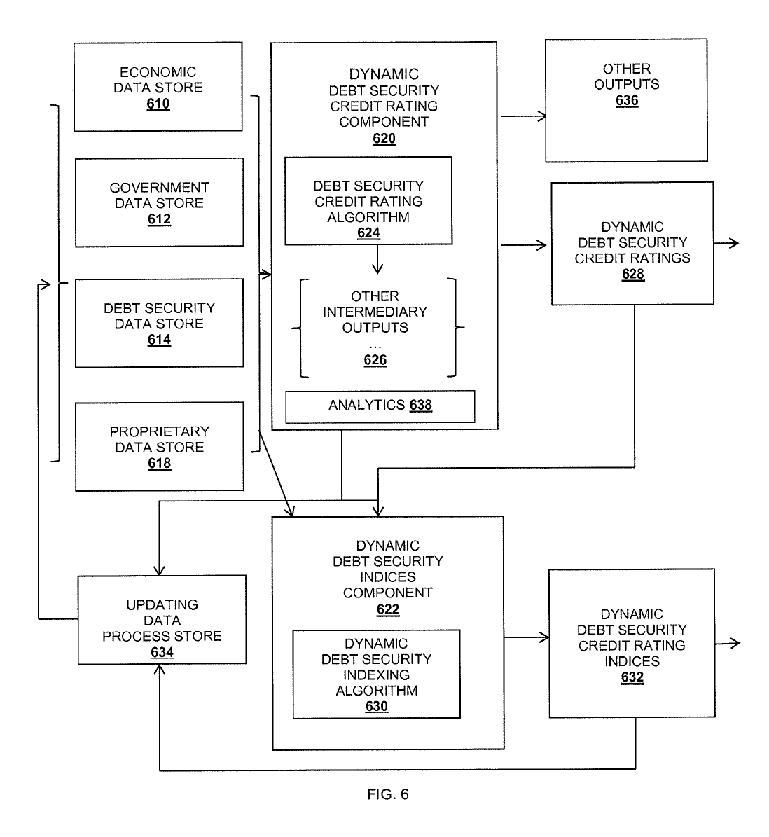

An embodiment can be understood with reference to FIG. 6, a flow diagram illustrating the flow of input debt security-related data into a dynamic debt security credit rating component and a dynamic debt security indices component for producing dynamic credit ratings and dynamic debt security indices with credit ratings.

In an embodiment, debt security related data, including but not limited to economic data 610, government data 612, debt security data 614, and proprietary data 618 are input into a dynamic debt security credit rating component 620. It should be appreciated that these data are by way of example only and are not meant to be limiting. In an embodiment, proprietary data 618 can include but are not limited to non-published or otherwise private data regarding a particular debt security or the underlying issuer. In an embodiment, proprietary data 618 can include fictitious or information constructed on-the-fly by a user to run the system to obtain results for further analysis.

Dynamic debt security credit rating component 620 contains a debt security credit rating algorithm 624. An exemplary algorithm is the algorithm described above and illustrated in FIG. 1. However, it should be appreciated that the algorithm can be any debt security credit rating algorithm that can be accessed via standard programming interfaces such as but not limited to application programming interfaces (API). In accordance with the embodiment, intermediary results from running the credit rating algorithm can be captured as intermediary outputs 626. In an embodiment, intermediary results 626 are configurable. That is, a user can configure component 620 to capture and store particular intermediary outputs. These outputs 626 can be outputted as other outputs 636 for further processing by other systems or users.

In an embodiment, the output of debt security credit rating algorithm 624 are dynamic debt security credit ratings 628. In an embodiment, dynamic debt security credit ratings 628 are sent out to other processes, such as for example reporting processes or other analysis processes.

As well, in an embodiment, dynamic debt security credit ratings 628 are inputted into a dynamic debt security indices component 622. As well, economic data store 610, government data store 612, debt security data store 614, and proprietary data store 618 can send data to dynamic debt security indices component 622. Dynamic debt security indices component 622 contains a dynamic debt security indexing algorithm 630 that uses the credit ratings and any relevant data from data stores 610-618 to generate one or more dynamic debt security credit rating indices 632. In an embodiment, dynamic debt security credit rating indices 632 are sent out to other processes, such as for example reporting processes or other analysis processes.

In an embodiment, dynamic debt security credit ratings 628 and dynamic debt security credit rating indices 632 are inputted into an updating data process 634. Updating data process 634 takes this data as well as any other current data (not shown) and updates economic data store 610, government data store 612, debt security data store 614, and proprietary data store 618, as appropriate.

In an embodiment, dynamic debt security credit rating component 620 contains an analytics component 638 that obtains real-time or historical data from data stores 610-618 to generate meaningful statistics regarding the securities and the respective credit ratings. For example, analytics component 638 can create graphs of trends regarding the history of the credit ratings of a particular set of bonds or of the credit ratings of bonds in a particular index.

### Providing High Quality, Accurate Analytic Capabilities for a Dynamically Generated Debt Security Credit Risk Rating

An embodiment uses a dynamically generated debt security credit risk rating in a multitude of analytic scenarios including but not limited to: comparing the rating to past ratings or predicted future ratings; comparing the rating with those of others that are similar such as in the same industry sector; comparing the rating with market assessments via metrics such as credit spreads; comparing the rating with ratings from other credit rating agencies.

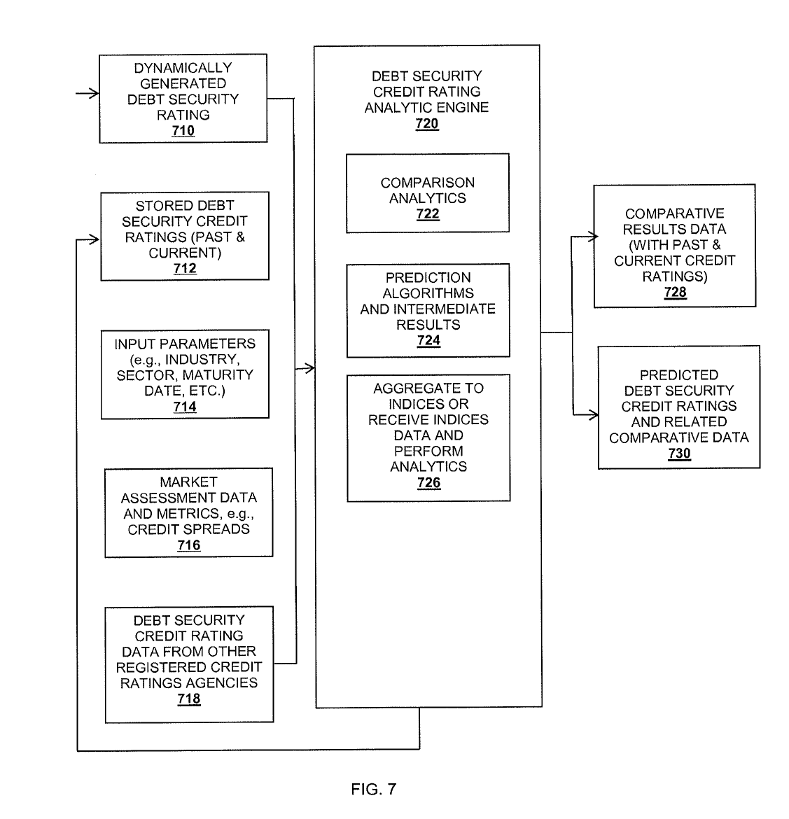

An embodiment can be understood with reference to FIG. 7, a flow diagram for providing high quality, accurate analytic capabilities for a dynamically generated debt security credit risk rating. A dynamically generated debt security rating 710 is either generated or received and is input into a debt security credit rating analytic engine 720. As well, other debt security related data are input into debt security credit rating analytic engine 720. This other debt security related data include but are not limited to stored debt security credit ratings (past and current) 712; input parameters, e.g. industry, sector, maturity date, etc. 714; market assessment data and metrics, e.g. credit spreads 716; and debt security credit rating data from other registered credit ratings agencies 718. It should be appreciated that data 712-718 can be user-configurable and can be data that are provided by financial institutions to the public. In an embodiment, a user interface is provided (not shown) to enable a user to enter, delete, or modify any of input data 712-718.

In an embodiment, debt security credit rating analytic engine 720 contains a comparison analytics component 722, a prediction algorithms and intermediate results component 724, and an aggregate to indices or receive indices data and perform analytics component 726.

In an embodiment, comparison analytics component 722 provides a variety of comparisons with the received debt security credit rating including but not limited to comparing the dynamically generated debt security credit rating to past debt security credit ratings or predicted future debt security credit ratings. Comparison analytics component 722 can compare the debt security credit rating with credit ratings of other debt securities. For example, the comparison can be among debt securities in the same industry sector. Comparison analytics component 722 can compare the debt security credit rating with market assessments via metrics such as credit spreads. As well, comparison analytics component 722 can compare the rating with ratings from other credit rating agencies. These particular comparisons are by way of example only and are not meant to be limiting.

In an embodiment, prediction algorithms and intermediate results component 724 uses one or more predictive models such as a neural network to evaluate the plurality of historical credit rating data and identify future credit ratings based on learned relationships among known variables.

In an embodiment, aggregate to indices or receive indices data and perform analytics component 726 can aggregate the received dynamically generated debt security credit rating and one or more other credit ratings assigned to one or more other debt securities into a dynamic debt security credit ratings index in real-time. As well, aggregate to indices or receive indices data and perform analytics component 726 can receive a dynamically generated debt security credit ratings index. With the dynamically generated debt security credit ratings index, generated or received, component 726 can perform various analytics. The various analytics can include but are not limited to employing weighting in the index based on various factors, where the weighting is user-configurable.

In an embodiment, debt security credit rating analytic engine 720 outputs comparative results data (with past and current credit ratings) 728 and predicted debt security credit ratings and related comparative data 730. In an embodiment, component 720 generates and outputs an adjusted interest rate required to be paid by the issuer of the debt security, based on the debt security credit rating.

### Providing Customizable Business Applications Using Dynamically Generated Debt Security Credit Risk Ratings

A system and method are provided that allow financial institutions such as banks, businesses, issuers, or investors to build customized workflows (or scenarios) or uses of dynamically generated debt security credit risk ratings. For example, given a dynamically generated rating, the system and method can compute the capital requirements of the issuing entity based on strict criteria such as regulatory rules and business rules. As another example, given a computed debt security credit risk rating, scenarios can be executed in which underestimated credit risk values or overestimated credit risk values are entered into the system to help determine the impact on the capital requirements of the underlying issuing entity. As another example, a user is able to make an adjustment with the company. For instance, if the credit rating is too low, then a feature within the company can be adjusted so that the company's risk of default becomes lower.

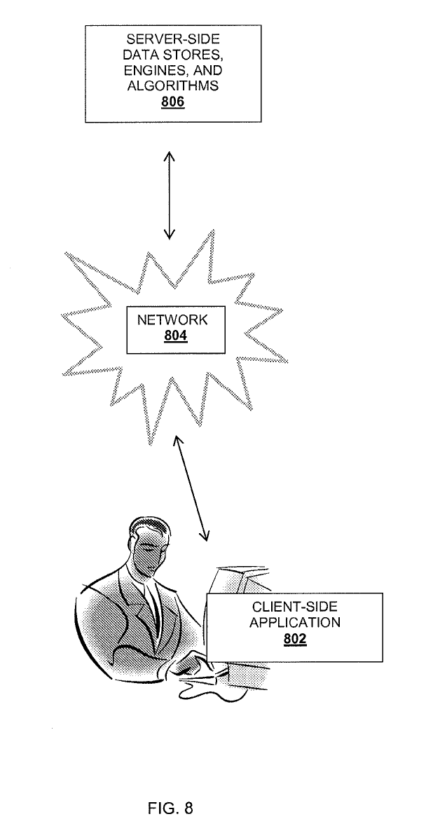

An embodiment can be understood with reference to FIG. 8, a schematic 25 diagram of a system and method for providing customizable business applications using dynamically generated debt security credit risk ratings.

In an embodiment, a user at a client-side application 802 is able to configure a customizable business application that uses the dynamically generated debt security credit ratings provided over a network 804 from server-side data stores, engines, and algorithms 806. It should be appreciated that in an embodiment, network 804 is a cloud network and server-side data stores, engines, and algorithms 806 are hosted on cloud network 804. In this implementation, client-side application 802 can be a web application where part of which are stored on client computer 802, parts may be added as a plug-in to a particular web browser (not shown), or client-side application 802 is just a web browser linking over network 804 to server-side data stores, engines, and algorithms 806. As well, server-side data stores, engines, and algorithms 806 may comprise one or more servers or clusters of servers.

In an embodiment, client-side application 802 is enabled to receive a dynamically generated debt security credit rating for a debt issuer and to enable the user, e.g. of a financial institution, to construct a customized workflow for achieving a desired business result, where the workflow uses the received dynamically generated debt security credit rating. In an embodiment, server-side 806 dynamically generates the debt security credit ratings using the algorithm as described in FIG. 1. It should be appreciated that when the algorithm provided herein as described above is used, the credit ratings are provided at a greater level of granularity than those provided from the standard credit rating agencies. Thus, the customizable workflows can be configured to perform at least as many operations as are credit ratings. Thus, because significantly more credit ratings are provided herein than compared to those provided by the standard credit rating agencies, a user is enabled to configure significantly more workflow paths and operations thereon.

In an embodiment, client-side application allows the user to configure a customized workflow that computes and outputs capital requirements of the debt issuer, where the computing is based on regulatory criteria and business rules applicable to the debt issuer (not shown.) The regulatory criteria and business rules can be provided through server-side 806 or can be stored on the client computer. It should be appreciated that capital requirements is by way of example only and is not meant to be limiting. For example, a workflow can be customized that computes and outputs the interest rate that the issuer is required to pay and then proceeds to make a payment. The workflow can be used to help inform a financial institution what it needs to do, e.g. based on rules, depending on the dynamically generated credit rating. For example, the workflow can alert a person within the organization when capital is too low and can cause a credit facility to input more capital to satisfy the requirements of the financial institution.

In an embodiment, the rules and attributes of the workflow are user-configurable. For example, the user can set or enter the attributes that are of important, their respective values and tolerances of their values. Then, the user can also configure the rules that are followed based on the values of the attributes.

In an embodiment, client-side 806 is configured to receive two or more dynamically generated debt security credit ratings for a debt issuer and to enable a financial institution 802 to construct a plurality of customized workflows, each customized workflow using one of the dynamically generated debt security credit rating for a debt issuer, wherein the customized workflows compute underestimated credit risk values or overestimated credit risk values to help determine impacts on the capital requirements. It should be appreciated that the steps may be performed on server-side 806 and client-side 802 accesses server-side 806 via network 804. For purposes of understanding herein, a financial institution is any of a: bank, business, issuer, or investor.

In an embodiment, client-side 802 is configurable so that upon receiving a plurality of dynamically generated debt security credit ratings for a plurality of debt issuers, debt security indices with credit ratings are dynamically generated using the plurality of dynamically generated debt security credit ratings. In an embodiment, the indices are grouped by industry type, credit rating, price, maturity date, and so on. The groupings are user-configurable.

In an embodiment, the financial institution 802 is able to define new workflows and modify existing workflows. For example, the user can construct a workflow that tells the user when to issue the new debt when trying to obtain a particular rating as the issuance of the debt may be market-dependent. A workflow can be configured to tell the financial institution it needs to save a particular amount of capital or funds. For example, a workflow can be configured to alert the financial institution when a credit rating rises above a specified threshold so that the financial institution knows it can issue the debt. A workflow can be configured to collect other debt instruments in addition to its underlying debt instrument so that the financial institution can determine where its debt instrument falls within the others in an index. These details are all illustrative and are not meant to be limiting as many other workflows can be constructed using the dynamically generated credit rating as described herein.

In an embodiment, the customized workflow determines an interest rate that an issuer is required to pay based on the dynamically generated debt security credit rating.

In an embodiment, based on the dynamically generated debt security credit rating, the customized workflow allows constructing scenarios that increase the credit rating to lower interest payments and other financing costs.

In an embodiment, the customized workflow allows a user to compute capital flows due by making changes to the dynamically generated debt security credit rating and allows a user to make changes to the capital flows to compute an updated dynamically generated debt security credit rating.

### Dynamic Bond Rating Services and Customer Interface

A variety of techniques are provided that facilitate and provide dynamic and real-time bond rating services to customers and investors. It should be appreciated that the use of bond is not meant to be limiting but is meant for illustrative purposes only. Other debt securities such as mortgage backed securities are included as well.

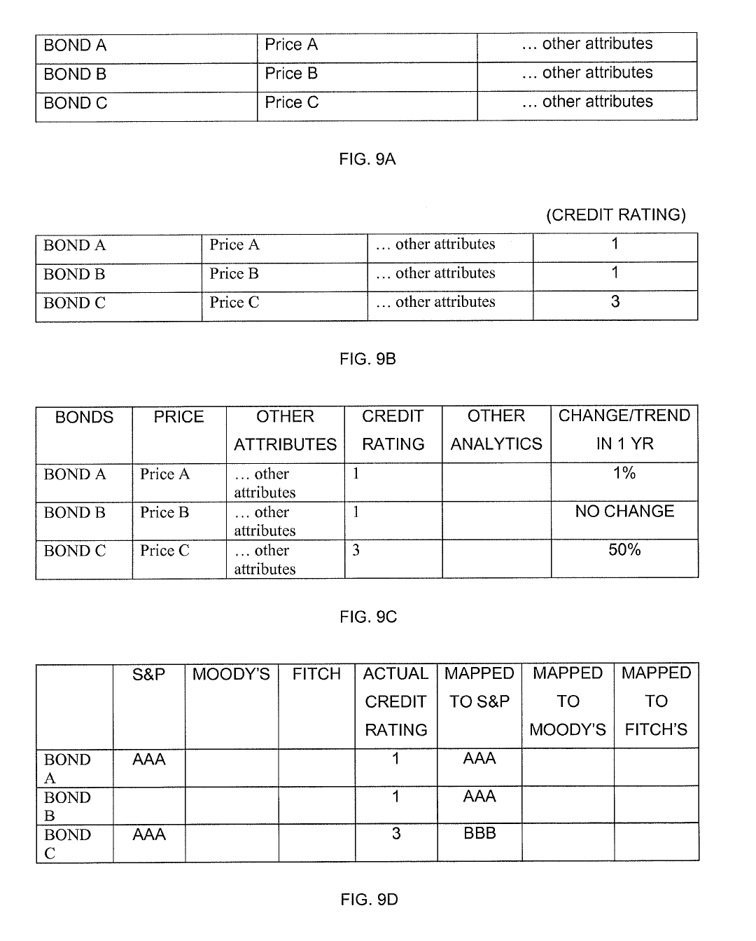

An embodiment can be understood with reference to FIG. 9A-9D, tables of bond portfolios and corresponding bond attributes used as input into a dynamic bond rating service and the respective output tables. For Table 9A, a user interface of a dynamic bond credit rating system such as that in FIG. 1 is provided for customers to input bond portfolio information for a corresponding bond portfolio. The bond portfolio information can include but is not limited to bond attribute values for the bonds such as price. Then, responsive to receiving the bond portfolio information, the system applies the received bond portfolio information to a dynamic bond credit rating algorithm that dynamically generates the bond credit ratings for each bond of the portfolio. Then the credit ratings are output, e.g. in a table such as that shown in FIG. 9B.

The dynamic bond rating services and customer interface described herein can be useful to investors or analysts wanting an optimal understanding of the composition of their bond portfolio as well as the quantified exposure of their bond portfolio.

In an embodiment, the system contains a bond rating analytics engine that computes and outputs related bond analytics and bond portfolio analytics. The types of bond analytics generated and outputted are user-configurable as not all analytics are desired by the same individuals. The particular analytics need not be described herein as many standard bond analytical functions are readily available in the market or are known in the industry.

In an embodiment, the related bond analytics and bond portfolio analytics comprise trend data of a specified attribute over a specified time period. An example is shown in FIG. 9C. Bond A shows a 1% change in a year. Bond B shows no change over the year, while Bond C shows a 50% change. The attribute whose change is being tracked can be the dynamic credit rating or any other specified attribute. The specified attribute and the specified time period are user-configurable.

In an embodiment, an interface is provided for a user or an automated process to input credit ratings of one or more standard credit rating agencies. The embodiment includes a conversion engine that converts the dynamically generated bond credit ratings to the corresponding credit ratings of the one or more standard credit rating agencies. For example in FIG. 9d, the dynamically generated credit rating of Bond C is 3, which is converted by the conversion engine to BBB for S&P. However, in the example, the actual credit rating given by S&P is AAA. Thus, by this example, it is shown that using the invention herein, an investor gleans more insight into a bond. That is, in this example, Bond C appears to be robust, holding a AAA rating. However, using the dynamic bond credit rating algorithm herein, the credit rating for the bond maps to a lower equivalent S&P bond rating. This inconsistent information can assist the investor, analyst, or any other interested user in making a more informed decision regarding whether to hold onto Bond C or to sell it and get it out of the bond portfolio.

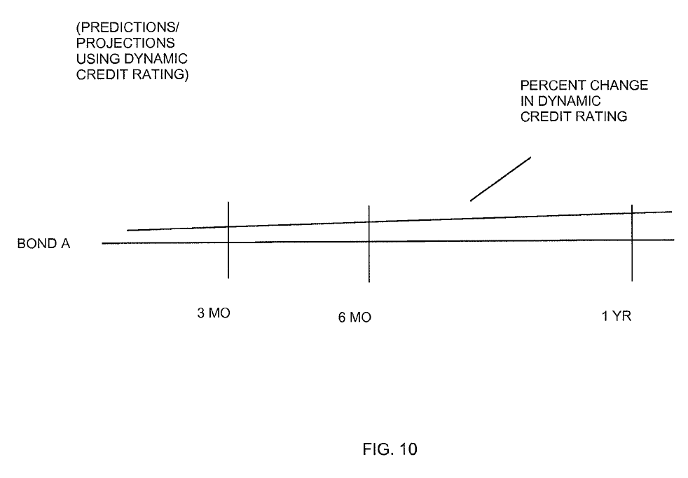

An embodiment can be understood with reference to FIG. 10, a schematic diagram showing the percent change in the dynamic credit rating for Bond A. In this embodiment, a user interface is provided to allow a user to configure input prediction parameters for one or more bonds. In the example in FIG. 10, the user chose time intervals of 3 months, 6 months, and 1 year for seeing any change in the attribute, dynamic credit rating. In the embodiment, a graph is generated which plots the percentage change in the dynamic credit rating over the specified time intervals. Thus, at a glance, the user can see an upward trend or increase in the credit rating for Bond A. It should be appreciated that when using the granular credit rating system described herein, the graph shows change that might not be detected when plotting the bond credit ratings as computed by the standard credit rating agencies. Thus, the granularity of the dynamic bond credit rating system allows a user to make a more informed decision regarding his or her held bonds.

### An Example Machine Overview

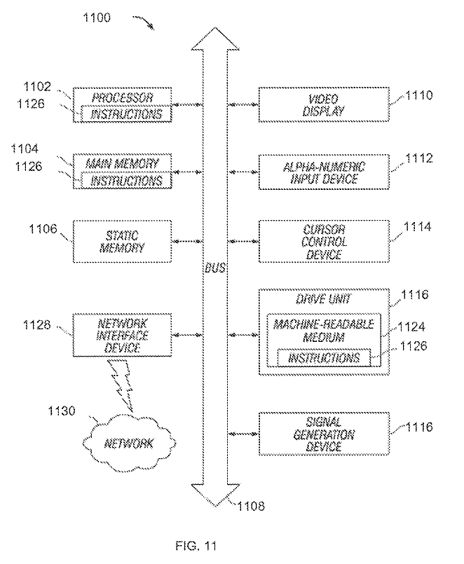

FIG. 11 is a block schematic diagram of a system in the exemplary form of a computer system 1100 within which a set of instructions for causing the system to perform any one of the foregoing methodologies may be executed. In alternative embodiments, the system may comprise a network router, a network switch, a network bridge, personal digital assistant (PDA), a cellular telephone, a Web appliance or any system capable of executing a sequence of instructions that specify actions to be taken by that system. The computer system 1100 includes a processor 1102, a main memory 1104 and a static memory 1106, which communicate with each other via a bus 1108. The computer system 1100 may further include a display unit 1110, for example, a liquid crystal display (LCD) or a cathode ray tube (CRT). The computer system 1100 also includes an alphanumeric input device 1112, for example, a keyboard; a cursor control device 1114, for example, a mouse; a disk drive unit 1116, a signal generation device 1118, for example, a speaker, and a network interface device 1128. The disk drive unit 1116 includes a machine-readable medium 1124 on which is stored a set of executable instructions, i.e. software, 1126 embodying any one, or all, of the methodologies described herein below. The software 1126 is also shown to reside, completely or at least partially, within the main memory 1104 and/or within the processor 1102. The software 1126 may further be transmitted or received over a network 1130 by means of a network interface device 1128. In contrast to the system 1100 discussed above, a different embodiment uses logic circuitry instead of computer-executed instructions to implement processing entities. Depending upon the particular requirements of the application in the areas of speed, expense, tooling costs, and the like, this logic may be implemented by constructing an application-specific integrated circuit (ASIC) having thousands of tiny integrated transistors. Such an ASIC may be implemented with CMOS (complementary metal oxide semiconductor), TTL (transistor-transistor logic), VLSI (very large systems integration), or another suitable construction. Other alternatives include a digital signal processing chip (DSP), discrete circuitry (such as resistors, capacitors, diodes, inductors, and transistors), field programmable gate array (FPGA), programmable logic array (PLA), programmable logic device (PLD), and the like. It is to be understood that embodiments may be used as or to support software programs or software modules executed upon some form of processing core (such as the CPU of a computer) or otherwise implemented or realized upon or within a system or computer readable medium. A machine-readable medium includes any mechanism for storing or transmitting information in a form readable by a machine, e.g. a computer. For example, a machine readable medium includes read-only memory (ROM); random access memory (RAM); magnetic disk storage media; optical storage media; flash memory devices; electrical, optical, acoustical or other form of propagated signals, for example, carrier waves, infrared signals, digital signals, etc.; or any other type of media suitable for storing or transmitting information. Further, it is to be understood that embodiments may include performing operations and using storage with cloud computing. For the purposes of discussion herein, cloud computing may mean executing algorithms on any network that is accessible by internet-enabled or network-enabled devices, servers, or clients and that do not require complex hardware configurations, e.g. requiring cables and complex software configurations, e.g. requiring a consultant to install. For example, embodiments may provide one or more cloud computing solutions that enable users, e.g. users on the go, to dynamically generate a debt security credit rating on such internet-enabled or other network-enabled devices, servers, or clients. It further should be appreciated that one or more cloud computing embodiments enable dynamically generating debt security credit ratings using mobile devices, tablets, and the like, as such devices are becoming standard consumer devices.

Although the invention is described herein with reference to the preferred embodiment, one skilled in the art will readily appreciate that other applications may be substituted for those set forth herein without departing from the spirit and scope of the present invention. Accordingly, the invention should only be limited by the Claims included below.

1. A computer-implemented method for dynamically generating debt security credit ratings, comprising:
receiving bond information;
performing analysis of a company or municipality that issued the bond based on the received bond information;
determining and assigning values to attributes of the bond based on the analysis of the company or municipality, wherein each bond attribute is given a weighting relative to the other bond attributes;
determining, by a scoring algorithm, a score for the bond, based on the bond weighted attribute values; and
determining a bond rating based on the score and a mapping of score ranges to bond ratings.

2. The method of claim 1, wherein when the bond is issued by a company, the bond attributes comprise:
cash flows;
profitability;
corporate structure; and
other leadership and operational information about the company.

3. The method of claim 1, wherein when the bond is issued by a municipality, the bond attributes comprise:
general economic data;
data regarding political stability of the geographic area of the municipality;
taxation data regarding the geographic area of the municipality; and other budgetary informational data.

4. The method of claim 1, further comprising:
receiving the weighting scheme as input for the bond attributes.

5. The method of claim 1, further comprising:
receiving the bond attributes as input.

6. The method of claim 1, wherein the scoring algorithm is configurable to set a desired level of granularity.

7. The method of claim 1, wherein the mapping of score ranges to bond ratings is configurable.

8. The method of claim 1, wherein a plurality of bond ratings are determined and wherein the underlying bonds are categorized by standard bond information and bond rating and aggregated into one or more bond indices.

9. The method of claim 1, further comprising:
improving accuracy of bond ratings by continually inputting bond default information and using the bond default information to determine the accuracy of the bond ratings and to adjust the scoring algorithm based on the determined accuracy.

10. A computer-implemented method for providing high quality, accurate analytic capabilities using a dynamically generated debt security credit rating, the method comprising:
receiving, at a debt security credit rating analytics engine, a dynamically generated debt security credit rating; and
using, by debt security credit rating analytics engine, the received debt security credit rating in performing any of:
comparing the dynamically generated debt security credit rating to past debt security credit ratings or predicted future debt security credit ratings;
comparing the debt security credit rating with credit ratings of other debt securities;
comparing the debt security credit rating with market assessments via metrics such as credit spreads; and
comparing the rating with ratings from other credit rating agencies.

11. The method of claim 10, further comprising:
aggregating the received dynamically generated debt security credit rating and one or more other credit ratings assigned to one or more other debt securities into a dynamic debt security credit ratings index in real-time or receiving a dynamically generated debt security credit ratings index; and
using the debt security credit ratings index to perform various analytics.

12. The method of claim 11, wherein performing various analytics including employing weighting in the index based on various factors.

13. The method of claim 10, wherein comparing the debt security credit rating with those of other debt securities include debt securities in the same industry sector.

14. The method of claim 10, further comprising:
determining an adjusted interest rate required to be paid by the issuer of the debt security, based on the debt security credit rating.

15. A computer-implemented method for providing customizable business applications using dynamically generated debt security credit ratings, the method comprising:
receiving a dynamically generated debt security credit rating for a debt issuer; and
enabling a financial institution to construct a customized workflow for achieving a business result, the workflow using the received dynamically generated debt security credit rating.

16. The method of claim 15, wherein the customized workflow computes and outputs capital requirements of the debt issuer, wherein the computing is based on regulatory criteria and rules applicable to the debt issuer.

17. The method of claim 15, further comprising:
receiving two or more dynamically generated debt security credit ratings for a debt issuer; and
enabling the financial institution to construct a plurality of customized workflows, each customized workflow using one of the dynamically generated debt security credit rating for a debt issuer, wherein the customized workflows compute underestimated credit risk values or overestimated credit risk values to help determine impacts on the capital requirements.

18. The method of claim 15, wherein said financial institution is any of a:
bank,
business,
issuer, or
investor.

19. The method of claim 15, further comprising:
receiving a plurality of dynamically generated debt security credit ratings for a plurality of credit facilities; and
dynamically generating debt security credit ratings indices using said plurality of dynamically generated debt security credit ratings.

20. The method of claim 15, further comprising:
enabling the financial institution to define new workflows and modify existing workflows.

21. The method of claim 15, wherein the customized workflow determines an interest rate that an issuer is required to pay based on the dynamically generated debt security credit rating.

22. The method of claim 15, wherein, based on the dynamically generated debt security credit rating, the customized workflow allows constructing scenarios that increase the credit rating to lower interest payments and other financing costs.

23. The method of claim 15, wherein the customized workflow allows a user to calculate capital flows due by making changes to the dynamically generated debt security credit rating and allows a user to make changes to the capital flows to calculate an updated dynamically generated debt security credit rating.

24. A computer-implemented method for generating dynamic data sets for real-time bond rating and related analytics, comprising:
receiving credit-worthiness structured and unstructured data from disparate sources including general economic data sources, government data sources, proprietary industry data sources, and bond data, wherein the data are received continually by a data updating process;
storing said received data in dynamic bond data sets; and
using, by a bond rating algorithm, said dynamic bond data sets periodically to generate or adjust dynamic real-time bond ratings and related analytics to quantify economic exposure in real time to underwriters;
wherein one or more steps are performed on at least a processor coupled to at least a memory.

25. The method of claim 24, further comprising:
dynamically aggregating the bonds and bond ratings into one or more dynamic credit rating indices in real-time.

26. The method of claim 24, further comprising:
improving accuracy of the output of the bond rating algorithm by employing machine neural network learning techniques that uses bond default data to determine the reliability of the bond rating on bonds that have defaulted.

27. The method of claim 24, wherein a level of granularity of the bond rating algorithm is configurable by the bond rating algorithm taking as input: bond attribute types, weights for each bond attribute type, a scoring scheme, and a rating scheme based on the scoring scheme.

28. A computer-implemented method for facilitating and providing dynamic and real-time bond rating services to customers, comprising:
provide a user interface for customers to input bond portfolio information for a corresponding bond portfolio, wherein the bond portfolio information comprises bond attribute values for the bonds;
responsive to receiving the bond portfolio information, applying the received bond portfolio information to a dynamic bond credit rating algorithm that dynamically generates bond credit ratings;
responsive to applying the received bond portfolio information to the dynamic bond credit rating algorithm, generating bond credit ratings for each of the bonds in the portfolio; and
outputting the bond credit ratings.

29. The method of claim 28, wherein customer comprise investors.

30. The method of claim 28, further comprising a bond rating analytics engine, wherein the bond rating analytics engine computes and output related bond analytics and bond portfolio analytics.

31. The method of claim 30, wherein the related bond analytics and bond portfolio analytics comprise trend data of a specified attribute over a specified time period.

32. The method of claim 31, wherein the specified attribute and the specified time period are user-configurable.

33. The method of claim 28, further comprising an interface to input credit ratings of one or more standard credit rating agencies and a conversion engine that converts the dynamically generated bond credit ratings to corresponding credit ratings of the one or more standard credit rating agencies.

34. The method of claim 28, further comprising a user interface to configure input prediction parameters for one or more bonds.

35. The method of claim 34, wherein the prediction parameters comprise specified time intervals.
